(19) United States
(12) Patent Application Publication
(10) Pub. No.: US 2022/0333898 A1
(43) Pub. Date: Oct. 20, 2022

(54) HIGH CLARITY RIFLE DISPLAY BEAM SPLITTER

(71) Applicant: Cubic Corporation, San Diego, CA (US)

(72) Inventors: Abram Summerfield, Orofino, ID (US); Brian Bellah, Orofino, ID (US)

(21) Appl. No.: 17/720,384

(22) Filed: Apr. 14, 2022

Related U.S. Application Data
(60) Provisional application No. 63/174,961, filed on Apr. 14, 2021.

(51) Int. Cl. F41G 1/38; F41G 11/00

(52) U.S. Cl. CPC F41G 1/38; F41G 11/003

(57) ABSTRACT

A high clarity rifle display beam splitter may include a housing defining a central conduit extending along a length of the housing. The central conduit may include first and second ends. A pellicle frame may be disposed within the central conduit. The pellicle frame may include a surface that is at an angle relative to a longitudinal axis of the pellicle frame. The pellicle frame may be secured to the housing along a central spine of the pellicle frame with a remaining portion of the pellicle frame floating relative to the housing to form an air gap between the pellicle and the housing. A pellicle may be mounted on the surface such that the pellicle is angled relative to the longitudinal axis. The pellicle may have a thickness of less than about 100 microns. Optical window may be coupled with each of the first and second ends.

### CROSS-REFERENCE TO RELATED APPLICATIONS

This application claims the benefit of and is a non-provisional of co-pending U.S. Provisional Application Ser. No. 63/174,961 filed on Apr. 14, 2021, which is hereby expressly incorporated by reference in its entirety for all purposes.

### BACKGROUND OF THE INVENTION

Beam splitters may be used in conjunction with rifle scopes to provide various functionality, such as enabling video of the sighted target to be captured, with the video perfectly matching a viewing angle of the scope. Conventional beam splitters are formed as thick, monolithic glass structures. For example, conventional beam splitters used with rifle scopes may include prism beam splitters and plate beam splitters. However, conventional beam splitters introduce several issues when used in rifle scopes or other afocal optics systems. For example, conventional beam splitters often include a lot of mass, typically do not have sufficient surface flatness to prevent image distortion, and therefore reduce the resolution of the associated optic. Additionally, conventional beam splitters often degrade the optical parameters of the host optic. In particular, the high magnification of the host optic (e.g., 25×) in combination with small flatness irregularities of the beam splitter blurs the image of the target through the riflescope. The degradation is sufficiently high that the degradation may prevent expert shooters from self-spotting their own rounds, may blur the image, and may negate the high-quality performance advantage of the basic scope. More specifically, prism beam splitters suffer from poor image quality and high material costs, prism beam splitters unsuitable for the commercial marketplaces. Prism beam splitters are quite bulky and the mass of glass required make the assembly quite heavy and unappealing. Additionally, the flatness required to achieve acceptable image quality makes the manufacturing of these items very expensive and not well suited for mass production. Plate beam splitters often produce ghosting of images and unacceptable image degradation to the associated optic. Therefore, improvements to beam splitters for afocal optics systems are desired.

### BRIEF SUMMARY OF THE INVENTION

Some embodiments of the present technology may encompass high clarity rifle display beam splitters. The beam splitters may include a housing defining a central conduit extending along a length of the housing. The central conduit may include an open first end and an open second end. The beam splitters may include a pellicle frame disposed within the central conduit of the housing. The pellicle frame may include a pellicle-receiving surface that is at an angle relative to a longitudinal axis of the pellicle frame. The pellicle frame may be secured to the housing along a central spine of the pellicle frame with a remaining portion of the pellicle frame floating relative to the housing to form an air gap between the remaining portion of the pellicle and the housing. The beam splitters may include a pellicle mounted on the pellicle-receiving surface such that the pellicle is angled relative to the longitudinal axis of the pellicle frame. The pellicle may have a thickness of less than about 100 microns. The beam splitters may include a first optical window coupled with the open first end. The beam splitters may include a second optical window coupled with the open second end.

In some embodiments, the pellicle frame may define an open interior. An interior of housing may include an airtight seal. A bottom surface of the pellicle frame may define an aperture aligned with an optical axis of the pellicle. A lens may be disposed within the aperture. The lens may include a doublet lens having a positive lenses that is coupled with a negative lens. The positive lens may be seated within the aperture and a peripheral edge of the negative lens may be seated against an outer surface of a portion of the pellicle frame that defines the aperture. The spine of the pellicle frame may be secured to the housing using one or both of a mechanical fastener and an adhesive.

Some embodiments of the present technology may encompass high clarity rifle display beam splitters that include a housing defining a central conduit extending along a length of the housing. The central conduit may include an open first end and an open second end. The beam splitters may include a pellicle frame mounted within the central conduit of the housing. An air gap may be formed between a substantial portion of an outer periphery of the pellicle frame and the housing. The beam splitters may include a pellicle mounted on the pellicle frame such that the pellicle is angled relative to the length of the housing. The pellicle may have a thickness of less than about 100 microns. The beam splitters may include a first optical window coupled with the open first end. The beam splitters may include a second optical window coupled with the open second end.

In some embodiments, the pellicle may be disposed at an angle of between about 30 degrees and 60 degrees relative to a longitudinal axis of the housing. The pellicle may have an optical transmission of at least 50%. The beam splitters may include an image device that is optically coupled with the pellicle. The image device may include one or both of a camera and a projector. The pellicle may be formed from a material selected from a group consisting of an organic celluloid film, a polymer, and a glass. A bottom surface of the pellicle frame may define an aperture aligned with an optical axis of the pellicle. A lens may be disposed within the opening. An angle of the pellicle may be selected to create an orthogonal optical transmission path between the lens and a reflecting surface of the pellicle.

Some embodiments of the present technology may encompass high clarity rifle display beam splitters that may include a housing defining a central conduit extending along a length of the housing. The central conduit may include an open first end and an open second end. The beam splitters may include a generally cylindrical pellicle frame mounted within the central conduit of the housing. An air gap may be formed between at least 270 degrees of an outer periphery of the pellicle frame and the housing. The beam splitters may include a pellicle mounted on the pellicle frame such that the pellicle is angled relative to the length of the housing. The pellicle may have a thickness of less than about 100 microns. The beam splitters may include a first optical window coupled with the open first end. The beam splitters may include a second optical window coupled with the open second end.

In some embodiments, the air gap may be formed between at least 300 degrees of the outer periphery of the pellicle frame and the housing. At least one of the first optical window, the second optical window, and the pellicle may include an optical treatment. The optical treatment may be selected from a group consisting of a tint, a filter, and a contrast enhancement. The filter may include at least one filter selected from a group consisting of a wavelength specific notch filter, a spectral band filter, and a wavelength specific band pass filter. One or both of the first optical window and the second optical window may include a magnifying lens.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a set of parentheses containing a second label that distinguishes among the similar components. If only the first reference label is used in the specification, the description is applicable to any one of the similar components having the same first reference label irrespective of the second reference label.

FIG. 1A illustrates a top isometric view of a pellicle and pellicle frame of a beam splitter according to embodiments of the present invention.

FIG. 1B illustrates a bottom isometric view of the pellicle and pellicle frame of FIG. 1A.

FIG. 2A illustrates a partial sectional isometric view of a beam splitter according to embodiments of the present invention.

FIG. 2B illustrates a partial sectional front elevation view of the beam splitter of FIG. 2A.

FIG. 2C illustrates a sectional side elevation view of the beam splitter of FIG. 2A.

FIG. 3 illustrates a sectional side elevation view of a scope assembly according to embodiments of the present invention.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention are directed to lightweight and substantially flat beam splitters. When used in conjunction with, or as part of an afocal or other optical system, the beam splitters may exhibit improved image quality (e.g., reduce degradation of image/beam quality) relative to conventional beam splitters. Image quality may be defined using metrics for resolution and contrast. For example, the commonly used Modulation Transfer Function (MTF) quantifies both the resolution and contrast metrics within one defined value. This value is typically given in units of “line-pairs per millimeter” (lp/mm) for focal systems, and “line-pairs per degree” (lp/deg) for afocal systems. The chosen resolution metric of line-pairs is then measured at a contrast percentage, with 100% being a “perfect” image. The final measurement is given in terms of “some percentage” at some “line-pair units.” For afocal riflescopes, a measurement would be called-out as a specific lp/deg, and a contrast percentage—e.g., MTF=50% @ 10 lp/deg. For a given optical design and application these values can change as needed based on the required product performance, thus providing a “pass/fail” value for production/evaluation. The use of the pellicle beam splitters described herein may increase the measurable lp/deg resolution at a lower contrast percentage for a riflescope (afocal system) over conventional thick-plate or cube beam splitters. The beams splitters do this by reducing the total wavefront deformation and/or aberration content, which degrades the image/beam quality, from the addition of a beam splitter into the path of the existing optical system (riflescope). Additionally, the beam splitters described herein are considerably lighter than conventional beam splitters, and may provide a larger display area as compared to a conventional beam splitter of a comparable size. To provide such benefits, beam splitters in accordance with the present invention may mount a thin pellicle (e.g., less than about 100 microns) on a pellicle frame that maintains the pellicle at an angle relative to the longitudinal axis of the frame and/or riflescope. The use of such a thin pellicle significantly reduces the weight of the beam splitter, and enables the beam-splitting surface to be more precisely fabricated (e.g., flatter) while reducing the overall cost of the beam splitter.

Embodiments of the present invention may be retrofitted to work in conjunction with existing scopes and/or integrated directly into the structure of a scope or other host optic. For example, the beam splitters may be utilized to provide a “smart scope”, which is a class of fire control riflescopes that provides an overlay of data in a field of view through the host optic. The data may include, for example, but is not limited to, reticles, the ballistically corrected aiming coordinates based on target range, gun/bullet type, atmospheric conditions, and/or other information. In retrofit applications, the beam splitters described herein may instantly convert a traditional riflescope into a smart scope with the pellicle beam splitter in the objective space.

While discussed primarily with respect to rifle scopes, it will be appreciated that the beam splitters may be used in other optical systems, such as, but not limited to, other afocal optical systems. For example, the beam splitters described herein may be utilized within laser optics, (e.g., as beam expanders), Infrared systems, forward looking infrared systems, camera zoom lenses, and telescopic lens attachments (e.g., teleside converters), binoculars, photography setups combining cameras and telescopes, and/or other optical systems.

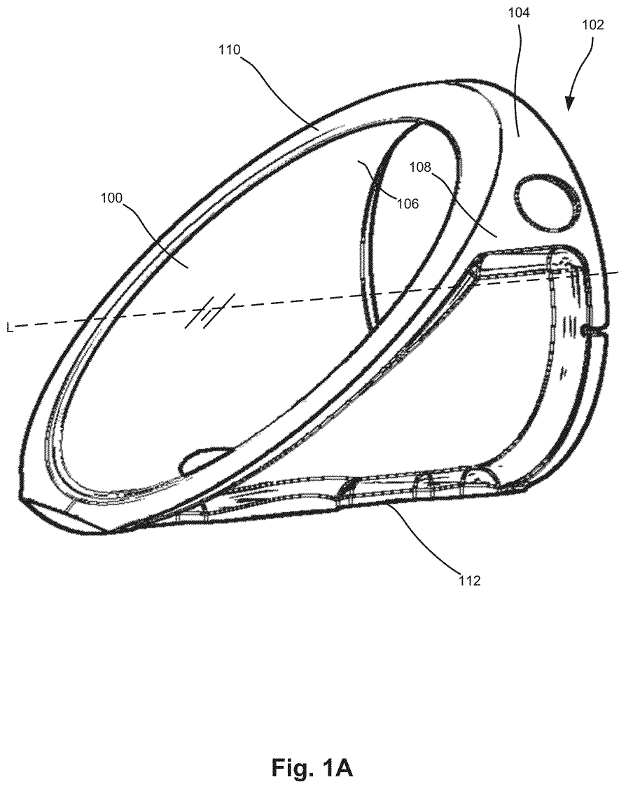

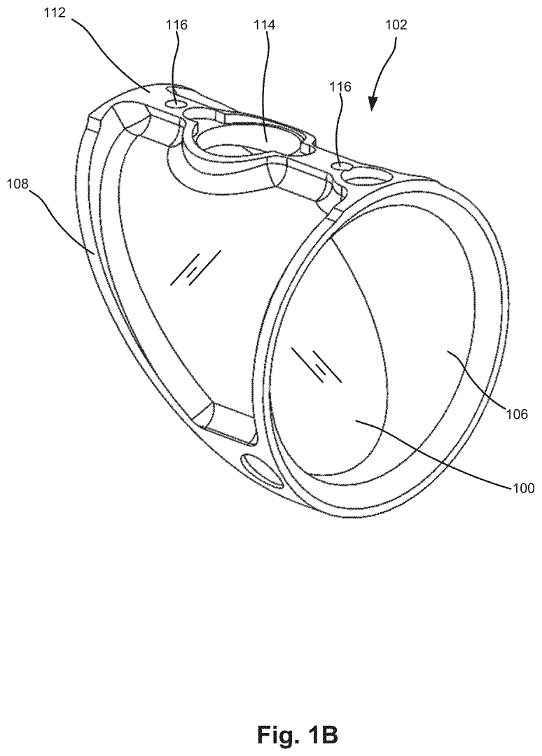

Turning now to FIGS. 1A and 1B, one embodiment of a pellicle 100 and pellicle frame 102 is illustrated. The pellicle frame 102 may include a body 104 that may define an open interior. For example, the body 104 may have a generally cylindrical (or any other shape) cross-section with an inner wall surface 106 and an outer wall surface 108 defining the geometry of the body 104. Inner wall surface 106 may define a periphery of the open interior of the pellicle frame 102. As best illustrated in the top isometric view of FIG. 1A, the pellicle frame 102 may include a pellicle-receiving surface 110 that may be at an angle relative to a longitudinal axis L of the pellicle frame 102. For example, the pellicle-receiving surface 110 may be a frontmost or rearmost surface of the pellicle frame 102 relative to the longitudinal axis L. The pellicle-receiving surface 110 may be at any angle between 1 and 89 degrees relative to the longitudinal axis L, but is commonly between about 30 degrees and 60 degrees, between about 35 degrees and 55 degrees, between about 40 degrees and 50 degrees, or about 45 degrees. In some embodiments, the pellicle-receiving surface 110 may slope upward from front to back, while in other embodiments the pellicle-receiving surface 110 may slope downward from front to back. The direction of the slope may be based on whether the pellicle 100 and pellicle frame 102 are utilized in an optical display configuration to display data generated by a projector or other image emitting device (e.g., upward slope from front to back) or in an optical capture configuration to direct optical data visible through the pellicle 100 to a camera or other image capture device (e.g., downward slope from front to back). The pellicle-receiving surface 110 may be machined to provide a flat surface (e.g., to within a sufficiently flat surface as to hold the beam splitter to minimal wavefront deformation, based the optical performance requirements; typically, less than 50 micron RMS for general applications) upon which the pellicle 100 may be mounted.

The pellicle frame 102 may include a spine 112, which may be positioned on a top, bottom, or other side of the pellicle frame 102. The position may be based on a direction of slope of the pellicle-receiving surface 110. For example, as illustrated, the pellicle-receiving surface 110 slopes upward from front to back to support the pellicle 100 in the optical display configuration, and the spine 112 is disposed on a bottom region of the pellicle frame 102 to provide a larger area to accommodate the spine 112. In the optical capture configuration, the spine 112 may be positioned on a top region of the pellicle frame 102 in some embodiments.

As best illustrated in the bottom isometric view of FIG. 1B, the spine 112 may define several features that may provide benefits over existing beam splitters. For example, an exterior surface of the spine 112 may extend or protrude radially outward from a rest of the outer wall surface 108 such that there is an offset or relief between the regions, which may substantially separate the pellicle 100 and pellicle frame 102 from a housing of a beam splitter as will be discussed in greater detail below. An amount of relief or offset between the spine 112 and the rest of the outer wall surface 108 may be less that or about 5 mm, less than or about 4 mm, less than or about 3 mm, less than or about 2 mm, less than or about 1 mm, less than or about 0.75 mm, less than or about 0.5 mm, less than or about 0.25 mm, less than or about 0.1 mm, less than or about 0.05 mm, or less. The spine 112 may include less than or about 20% of the entire outer wall surface 108, less than or about 15%, less than or about 10%, less than or about 5%, or less. In embodiments in which a cross-section of the outer wall surface 108 is generally circular, the spine 112 may extend along less than or about 72 degrees of the cross-section, less than or about 54 degrees, less than or about 36 degrees, less than or about 18 degrees, less than or about 9 degrees, or less.

The spine 112 may define at least one lens aperture 114, which may be designed to receive one or more lenses (or lens assemblies) that may be used to exchange optical data between the pellicle 100 and one or more image devices that are optically coupled with the pellicle 100. A position of the lens aperture 114 within the spine 112 may be determined by an angle of the pellicle 100 and pellicle-receiving surface 110 and/or an angle of the pellicle 100 and pellicle-receiving surface 110 may be set based on a position of the lens aperture 114. For example, the angle of the pellicle 100 and pellicle-receiving surface 110 and a position of the lens aperture 114 may be selected to form an orthogonal optical transmission path between a lens disposed within the lens aperture 114 and a reflecting surface of the pellicle 100. For example, the angle of the pellicle 100 and pellicle-receiving surface 110 and a position of the lens aperture 114 may be selected such that the optical transmission path between optical axis of the lens and the pellicle 100 is orthogonal to the longitudinal axis L.

The spine 112 may define one or more apertures 116 that may be used to secure the pellicle frame 102 to a larger housing as will be described in greater detail below. For example, the apertures 116 may be threaded such that fasteners, such as bolts and/or screws, may be used to secure the pellicle frame 102 to a larger housing and/or other assembly. As illustrated, the spine 112 includes one aperture 116 on either side of lens aperture 114, however other configurations are possible in various embodiments. For example, in some embodiments, one or both sides of the spine 112 (relative to the lens aperture 114) may include no apertures 116, while in other embodiments one or both sides of the spine 112 may include multiple apertures 116.

In some embodiments, the pellicle frame 102 may be constructed from a complex aluminum (or other lightweight, rigid material) structure that positions the pellicle 100 at a desired angular orientation relative to the longitudinal axis L over the full aperture of the objective space of the riflescope or other host optic, thereby eliminating image degradations. For example, the pellicle frame 102 may be machined from aluminum and may be designed to securely hold the pellicle 100 taut across an elliptical clear aperture. This ellipse, when positioned at a 45-degree angle (or other angle) provides a round field of view compatible with the riflescope and/or other host optic. The unique wedge shape provides the necessary structure to maintain near perfect flatness across the membrane mounting surface, while also providing mechanical area for fasteners and/or adhesive bedding along the spine 112 of the pellicle frame 102 to secure the pellicle frame 102 to a larger housing or other assembly of the beam splitter.

The pellicle 100 may be a thin piece of partially reflective material. For example, the pellicle may include an optical transmission of at least or about 50%, at least or about 60%, at least or about 70%, at least or about 80%, or more, although optical transmissions between 60% and 70% are most common. Such optical transmissions may enable the pellicle 100 to act as a beam splitter to enable an original image (such as a field of view through a scope or other optic) to be clearly visible through the pellicle 100, while optical data may be transmitted to an image capture device and/or output images may be received from an image generator device and displayed by the pellicle 100 as an overlay over the field of view of the optic. The pellicle may be formed from various materials, such as one or more types of polymers and/or glasses. In some embodiments, the pellicle 100 may be formed from an organic celluloid film and/or a polymer such as biaxially-oriented polyethylene terephthalate, however other transparent materials may be utilized in various embodiments.

The pellicle 100 may be made to be as planar as possible, which may help reduce or eliminate wavefront deformation caused by the pellicle 100. For example, the pellicle 100 may be flat to within about 0.5 waves (λ/2) or better for a 25× magnification riflescope. The pellicle 100 may have a thickness of less than about 100 microns. For example, the thickness may be between or about 2 microns and 100 microns, between or about 2 microns and 90 microns, between or about 2 microns and 80 microns, between or about 2 microns and 70 microns, between or about 2 microns and 60 microns, between or about 2 microns and 50 microns, between or about 2 microns and 40 microns, between or about 2 microns and 30 microns, between or about 2 microns and 25 microns, between or about 2 microns and 20 microns, or between or about 10 microns and 20 microns. By making the pellicle 100 sufficiently flat and sufficiently thin, wavefront deformation of the pellicle 100 may be substantially or entirely eliminated, which may result in better image quality/resolution through the primary optic. Additionally, such thicknesses may substantially reduce the weight of the pellicle 100, effectively making the pellicle 100 add zero mass to the final beam splitter assembly. Thicker pellicles may increase the weight of the beam splitter assembly and may also introduce higher levels of wavefront deformation that may reduce the image quality and clarity of the primary optic. Thinner pellicles may be difficult to manufacture and/or may be difficult to securely mount to the pellicle frame 102.

The pellicle 100 may be secured to pellicle-receiving surface 110 of the pellicle frame 102 such that the pellicle 100 is angled relative to the longitudinal axis L of the pellicle frame 102. As noted above, both the pellicle 100 and pellicle-receiving surface 110 may be fabricated to be as flat as possible, which may help improve the coupling between the components and may ensure that the pellicle 100 is precisely disposed at a desired angle (e.g., the angle of the pellicle 100 matches the angle of the pellicle-receiving surface 110 and is as close to perfectly oriented at a designed angle as possible). Such an arrangement may ensure that the pellicle 100 has a first optical axis that is parallel or coaxial to the longitudinal axis L and a second optical axis that is orthogonal to the longitudinal axis L. In some embodiments, the pellicle 100 may be secured to the pellicle-receiving surface 110 via an adhesive, such as a thermally active adhesive, although other adhesives and/or securement techniques may be used in various embodiments. To cover the entire pellicle-receiving surface 110, the pellicle 100 may be generally elliptical in some embodiments.

In some embodiments, the pellicle 100 may include one or more coatings, treatments, and/or other surface modifications. For example, the pellicle 100 may be treated/coated with and/or otherwise include a tint, a contrast enhancement, a pure partially reflecting material, a wavelength specific notch filter, a band pass filter, a filter for a special regimes of a spectral band, and/or other treatment, etc. to meet the needs of a particular application.

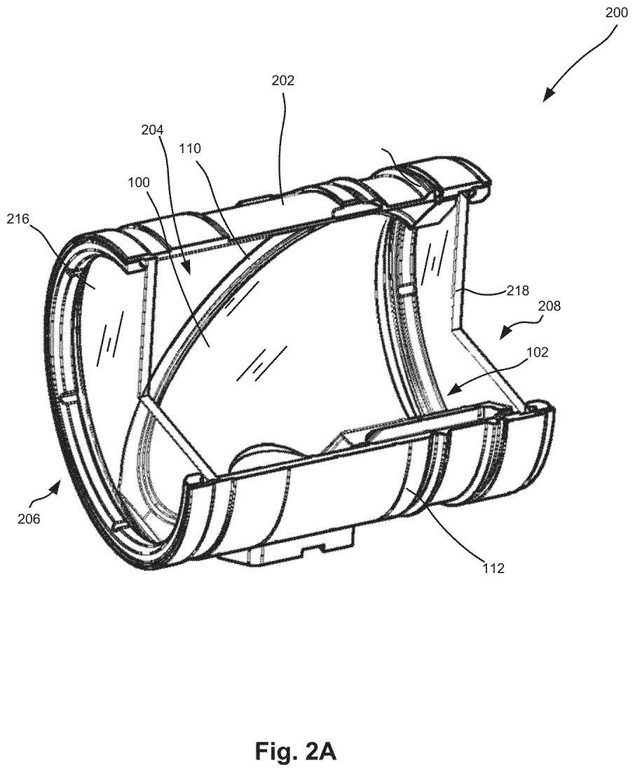

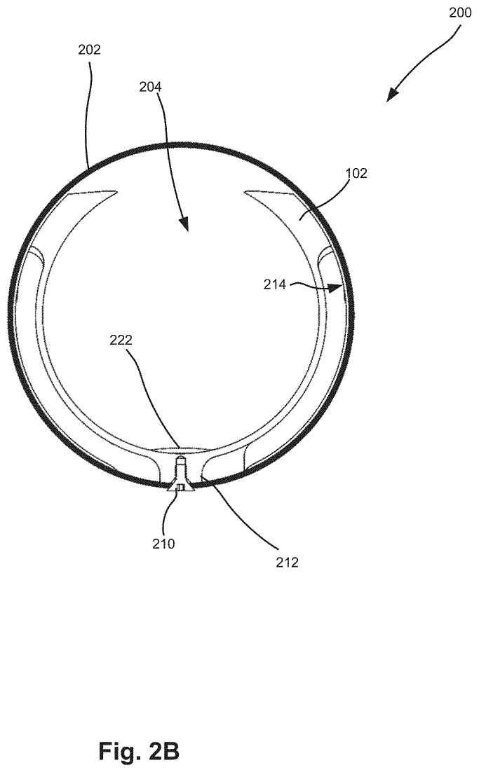

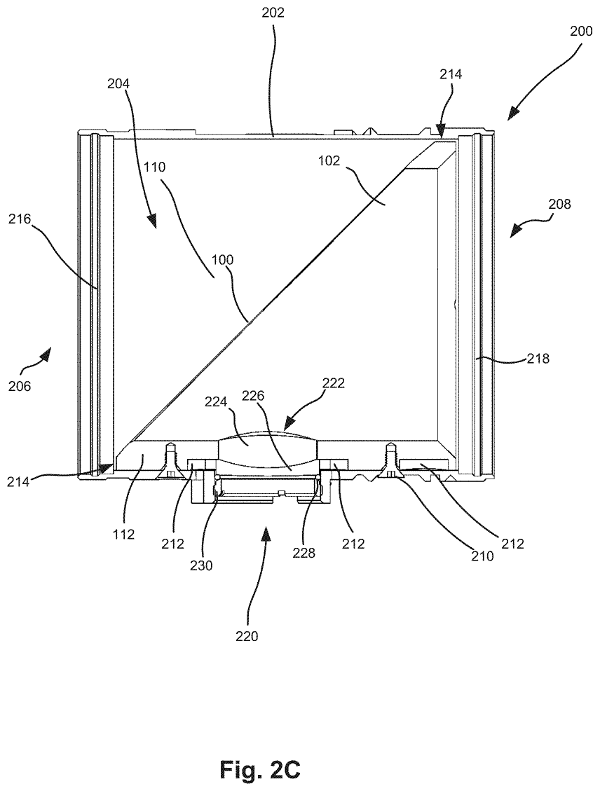

FIGS. 2A-2C illustrate an embodiment of a beam splitter 200. Beam splitter 200 may include the pellicle 100 and pellicle frame 102, which may be mounted within a beam splitter housing 202. The housing 202 may have any cross-sectional shape, and may be generally cylindrical in some embodiments. The housing 202 may define a central conduit 204 along a length of the housing 202. The central conduit 204 may include an open first (e.g., front) end 206 and an open second (e.g., rear) end 208. The central conduit 204 may have a larger diameter (or other lateral dimension) than the pellicle frame 102 such that the pellicle frame 102 may be received within the central conduit 204 without the outer surfaces of the pellicle frame 102 contacting the housing along a substantial portion of an outer periphery of the pellicle frame 102. For example, the spine 112 of the pellicle frame 102 may be mounted to an interior surface of the housing 202 such that the pellicle 100 is angled with respective to a length and longitudinal axis of the housing 202 (which may be coaxial and/or parallel with the longitudinal axis L of the pellicle frame 102). For example, one or more fasteners 210 and/or an adhesive 212 may be used to secure the spine 112 to an interior surface (such as an interior bottom or top surface) of the housing 202. As illustrated fasteners 210 are inserted through apertures (not shown) defined within the housing 202 and engaged with threads of the apertures 116 of the pellicle frame 102. Adhesive 212 may be applied in one or more places to help secure the spine 112 with the interior surface of the housing 202. For example, the adhesive 212 may be applied at one or more locations on either side of lens aperture 114, between the apertures 116, and/or outside of apertures 116.

In some embodiments, when the spine 112 is mounted to the housing, only the spine 112 may contact any surface of the housing 202 such that an air gap 214 is formed between a substantial portion of an outer periphery of the pellicle frame and the housing. For example, the air gap 214 may extend about greater than or about 80% of the entire outer wall surface 108, greater than or about 85%, greater than or about 90%, greater than or about 95%, or more. In embodiments in which a cross-section of the outer wall surface 108 of the pellicle frame 102 is generally circular, the air gap 214 may extend along greater than or about 270 degrees of the cross-section, greater than or about 288 degrees greater than or about 300 degrees, greater than or about 324 degrees, greater than or about 340 degrees, greater than or about 354 degrees, or more. The air gap 214 may enable the pellicle frame 102 (and pellicle 100) to be substantially floating relative to the housing 202. By substantially floating the pellicle frame 102 and pellicle 100, the beam splitter 200 may enable thermal expansion of the various components without risk of deformation of the pellicle 100. Additionally, when mounted on a scope, the substantially floating nature of the pellicle 100 and pellicle frame 102 may help prevent the pellicle from being impacted (e.g., being distorted, deformed, and/or otherwise damaged) by outside forces, such as physical hoop stresses that may apply a crushing force to the housing 202.

The beam splitter 200 may include a first optical window 216 that is interfaced with the first end 206 and a second optical window 218 that is interfaced with the second end 208. The optical windows 216, 218 may be formed from a transparent material and may effectively seal ends 206, 208 of the housing 202. In some embodiments, seals, such as O-rings, may be included to better create an airtight seal at the interface of each optical window 216, 218 and its respective end 206, 208 of the housing 202. The optical windows 216, 218 may have a sufficient surface flatness so as to reduce or minimize wavefront distortions. The optical windows 216, 218 may protect the pellicle 100 from external shock, such as air pressure spikes associated with gunfire muzzle blast, as well as ingress from water, dirt, and/or other particulate. The optical windows 216, 218 may include a polymeric material, a glass, or other protective transparent material. In some embodiments, the optical windows 216, 218 may be plain sheets of material, while in other embodiments one or both optical windows 216, 218 may include one or more coatings, treatments, and/or other surface modifications. For example, the optical windows 216, 218 may be treated/coated with and/or otherwise include a tint, a polarization treatment, an anti-reflective treatment, a color and/or contrast enhancement, a pure partially reflecting material, a wavelength specific notch filter, a band pass filter, a filter for a special regimes of a spectral band, and/or other treatment, etc. to meet the needs of a particular application. In some embodiments, one or both of the optical windows 216, 218 may be provided in the form of a magnifying lens (or lens assembly), which may include one or more positive lenses, one or more negative lenses, and/or one or more doublet lens stacks. In such embodiments, the beam splitter 200 may provide additional optical enhancement of a field of view of an attached scope or other optic, or may form the full optic itself. For example, the beam splitter 200, with one or more magnifying lenses on one or both sides of the pellicle 100, may be used as a smart scope (or other smart optic) without the need for any other magnifying lenses or lens assemblies.

The housing 202 may define an opening 220 in a bottom surface of the housing 202. The opening 220 may be aligned with the lens aperture 114 of the pellicle frame 102. A lens 222 may be installed into the pellicle frame 102 and housing 202. For example, all or a portion of the lens 222 may be seated within the lens aperture 114 in some embodiments. In a particular embodiment, the lens 222 may be a doublet lens that includes a positive lens 224 and a negative lens 226. The positive lens 224 and the negative lens 226 may be coupled with one another, such as using an optical cement. In some embodiments, the positive lens may be seated within the lens aperture 114 of the pellicle frame 102 such that peripheral edges of the positive lens 224 are seated against an inner wall defining the lens aperture 114. The negative lens 226 may be disposed within the opening 220, with a peripheral edge of the negative lens 226 being seated against a lower/outer surface of a portion of the pellicle frame 102 that defines the lens aperture 114. Such an arrangement may ensure that the lens 222 is keyed into the pellicle frame 102 to properly align a central or optical axis of the lens 222 with an optical axis of the pellicle 100. For example, the angle of the pellicle 100 may be selected to create an orthogonal optical transmission path between the lens 222 and the optical axis of the pellicle 100.

In some embodiments, an O-ring 228 (or other sealing element) and/or a locking ring 230 (or other securement mechanism) may be interfaced with a portion of the opening 220 below the lens 222. These components may help maintain the lens 222 at a desired position within the pellicle frame 102 and housing 202, as well as seal the interior of the housing 202. Once O-ring 228, locking ring 230, and optical windows 216, 218 are interfaced with the housing 202, the housing 202 may have an airtight seal, which may help protect the pellicle 100 from external shock such as air pressure spikes associated with gunfire muzzle blast. The airtight seal may also prevent the ingress of moisture, dirt, and/or other contaminates into the interior of the beam splitter 200, which may help prevent fogging and/or formation of ice crystals, etc. In some embodiments, the sealed interior of the beam splitter 200 may be nitrogen purged. For example, a small purge port may be positioned on the outside diameter of the housing 202 to allow for nitrogen purging (or other purging techniques), as a means of expelling any moisture from within the sealed system.

The beam splitter 200 may be mounted and/or otherwise secured to an additional device, such as a rifle, binoculars, riflescope, spotting scope, camera, and/or other optical system. For example, the housing 202 may include one or more fasteners, clamps, receptacles, and/or other interfaces that may enable the beam splitter 200 to be interfaced with one or more additional devices.

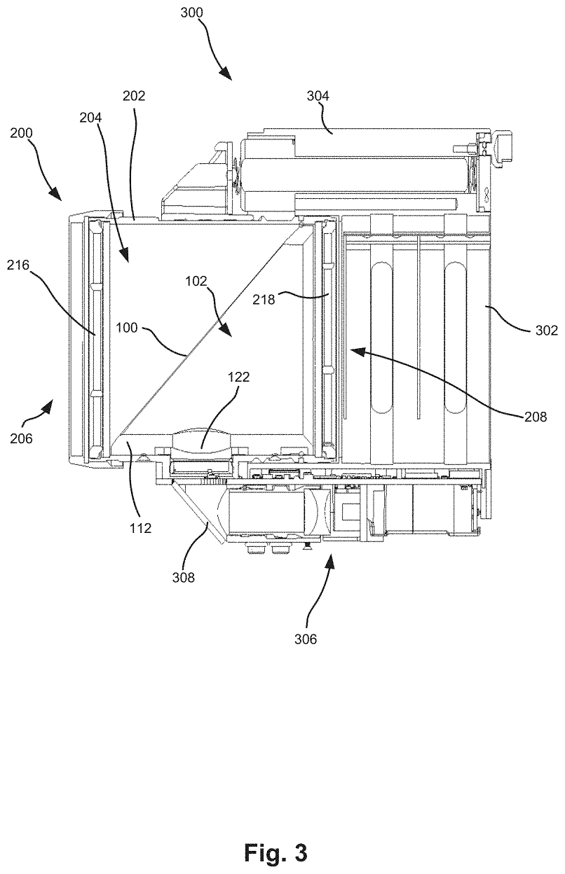

FIG. 3 illustrates a scope assembly 300 according to embodiments of the present invention. The scope assembly may include beam splitter 200 in some embodiments. For example, the beam splitter 200 may be disposed adjacent to a scope 302 and/or other optic including one or more magnifying lenses, with a longitudinal axis and a first optical axis (that is coaxial with the longitudinal axis) of the beam splitter 200 being coaxial with the longitudinal axis and optical axis of the scope 302. As illustrated, a coupling mechanism 304 (such as a clamp, fastener, or other mechanical securement device) may be used to secure the beam splitter 200 and scope 302 together.

Disposed beneath the beam splitter 200 and/or scope 302 may be an image device 306 that may be optically coupled with the pellicle 100. Image device 306 may include one or more image capture devices, such as cameras, and/or one or more image generator devices, such as projectors. As illustrated, the image device 306 may enable information to be projected and/or otherwise overlaid over a portion of the field of view of the scope 302, such as by projecting the image onto the pellicle 100. In other embodiments, the pellicle 100 may be used to transmit data from the field of view of the scope 302 to an image capture device. For example, the orientation of the pellicle 100 may be reversed such that the pellicle 100 slopes downward from front to back. The pellicle 100 may then reflect a portion of the image viewed through the scope 302 and beam splitter 200 into the image capture device. In some embodiments, an optical axis of the image device 306 may be aligned with the optical axis of the lens 222 and a second optical axis (that is orthogonal to the longitudinal axis L and coaxial with the optical axis of the lens 222) of the pellicle 100. However, as illustrated, the image device 306 is disposed in a manner such that the optical axis of the image device 306 is orthogonal to the optical axis of the lens 222 and the second optical axis of the pellicle 100. In such configurations, a reflector 308, such as a mirror, may be positioned (such as at a 45 degree angle relative to the orthogonal axes) and used to optically couple the optical axis of the image device 306 with the optical axis of the lens 222 and the second optical axis of the pellicle 100. It will be appreciated that numerous other configurations of the various optical axes may be utilized, with any number (including zero) of reflectors being used to optically couple the various components.

While shown with the beam splitter 200 positioned in front of the scope 302, it will be appreciated that the beam splitter 200 may be positioned rearward of the scope 302 in some embodiments, and may be integrated into the scope 302 in some embodiments. For example, the beam splitter 200 may be positioned between front and rear lenses of the scope or other optic.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

While illustrative and presently preferred embodiments of the disclosed systems and devices have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein. As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

What is claimed is:

1. A high clarity rifle display beam splitter, comprising:
a housing defining a central conduit extending along a length of the housing, the central conduit comprising an open first end and an open second end;
a pellicle frame disposed within the central conduit of the housing, the pellicle frame comprising a pellicle-receiving surface that is at an angle relative to a longitudinal axis of the pellicle frame, wherein the pellicle frame is secured to the housing along a central spine of the pellicle frame with a remaining portion of the pellicle frame floating relative to the housing to form an air gap between the remaining portion of the pellicle and the housing;
a pellicle mounted on the pellicle-receiving surface such that the pellicle is angled relative to the longitudinal axis of the pellicle frame, the pellicle having a thickness of less than about 100 microns;
a first optical window coupled with the open first end; and
a second optical window coupled with the open second end.

2. The high clarity rifle display beam splitter of claim 1, wherein:
the pellicle frame defines an open interior.

3. The high clarity rifle display beam splitter of claim 1, wherein:
an interior of the housing comprises an airtight seal.

4. The high clarity rifle display beam splitter of claim 1, wherein:
a bottom surface of the pellicle frame defines an aperture that is vertically aligned with an optical axis of the pellicle; and
a lens is disposed within the aperture.

5. The high clarity rifle display beam splitter of claim 4, wherein:
the lens comprises a doublet lens having a positive lenses that is coupled with a negative lens.

6. The high clarity rifle display beam splitter of claim 5, wherein:
the positive lens is seated within the aperture and a peripheral edge of the negative lens is seated against an outer surface of a portion of the pellicle frame that defines the aperture.

7. The high clarity rifle display beam splitter of claim 1, wherein:
the spine of the pellicle frame is secured to the housing using one or both of a mechanical fastener and an adhesive.

8. A high clarity rifle display beam splitter, comprising:
a housing defining a central conduit extending along a length of the housing, the central conduit comprising an open first end and an open second end;
a pellicle frame mounted within the central conduit of the housing, wherein an air gap is formed between a substantial portion of an outer periphery of the pellicle frame and the housing;
a pellicle mounted on the pellicle frame such that the pellicle is angled relative to the length of the housing, the pellicle having a thickness of less than about 100 microns;
a first optical window coupled with the open first end; and
a second optical window coupled with the open second end.

9. The high clarity rifle display beam splitter of claim 8, wherein:
the pellicle is disposed at an angle of between about 30 degrees and 60 degrees relative to a longitudinal axis of the housing.

10. The high clarity rifle display beam splitter of claim 8, wherein:
the pellicle has an optical transmission of at least 50%.

11. The high clarity rifle display beam splitter of claim 8, further comprising:
an image device that is optically coupled with the pellicle.

12. The high clarity rifle display beam splitter of claim 11, wherein:
the image device comprises one or both of a camera and a projector.

13. The high clarity rifle display beam splitter of claim 8, wherein:
the pellicle is formed from a material selected from a group consisting of an organic celluloid film, a polymer, and a glass.

14. The high clarity rifle display beam splitter of claim 8, wherein:
a bottom surface of the pellicle frame defines an aperture that is vertically aligned with an optical axis of the pellicle;
a lens is disposed within the opening; and
an angle of the pellicle is selected to create an orthogonal optical transmission path between the lens and a reflecting surface of the pellicle.

15. A high clarity rifle display beam splitter, comprising:
a housing defining a central conduit extending along a length of the housing, the central conduit comprising an open first end and an open second end;
a generally cylindrical pellicle frame mounted within the central conduit of the housing, wherein an air gap is formed between at least 270 degrees of an outer periphery of the pellicle frame and the housing;
a pellicle mounted on the pellicle frame such that the pellicle is angled relative to the length of the housing, the pellicle having a thickness of less than about 100 microns;
a first optical window coupled with the open first end; and
a second optical window coupled with the open second end.

16. The high clarity rifle display beam splitter of claim 15, wherein:
the air gap is formed between at least 300 degrees of the outer periphery of the pellicle frame and the housing.

17. The high clarity rifle display beam splitter of claim 15, wherein:
at least one of the first optical window, the second optical window, and the pellicle comprises an optical treatment.

18. The high clarity rifle display beam splitter of claim 17, wherein:
the optical treatment is selected from a group consisting of a filter, a polarization control treatment, an anti-reflection treatment, and a color and contrast enhancement.

19. The high clarity rifle display beam splitter of claim 18, wherein:
the filter comprises at least one filter selected from a group consisting of a wavelength specific notch filter, a spectral band filter, and a wavelength specific band pass filter.

20. The high clarity rifle display beam splitter of claim 15, wherein:
one or both of the first optical window and the second optical window comprises a magnifying lens.
